(19) United States
(12) Patent Application Publication
(10) Pub. No.: US 2023/0302919 A1
(43) Pub. Date: Sep. 28, 2023

(54) Method and Device for Controlling an Electric Drive System for an Electric Vehicle

(71) Applicant: Vitesco Technologies GmbH, Regensburg (DE)

(72) Inventors: Martin Jehle, Pettendorf (DE); Damien Verdier, Toulouse (FR); Jérôme Lachaize, Toulouse (FR)

(73) Assignee: Vitesco Technologies GmbH, Regensburg (DE)

(21) Appl. No.: 18/326,521

(22) Filed: May 31, 2023

Related U.S. Application Data
(63) Continuation of application No. PCT/EP2021/084244, filed on Mar. 12, 2021.

(30) Foreign Application Priority Data
Mar. 12, 2020 (DE) 10 2020 215 328.0

(51) Int. Cl. B60L 15/20; B60L 50/70; B60L 1/00

(52) U.S. Cl. CPC B60L 15/20; B60L 50/70; B60L 1/00; B60L 2240/423; B60L 2240/421; B60L 50/60

(57) ABSTRACT

A method for controlling an electric drive system for an electric vehicle, the electric drive system being subdivided in an electric machine subsystem having a first electric machine and a second electric machine and in a remaining subsystem having at least an electric storage device. The method includes: determining an allowable remaining system power range for the remaining system; determining an allowable first machine power range for the first electric machine and an allowable second machine power range for the second electric machine; and determining an allowable first machine torque range. The method also includes: determining an allowable second machine torque range; determining a first machine torque setpoint for the first electric machine and determining a second machine torque setpoint for the second electric machine; and operating first electric machine to realize first machine torque setpoint and operating second electric machine to realize second machine torque setpoint.

### CROSS-REFERENCE TO RELATED APPLICATIONS

This application claims the benefit of PCT Application PCT/EP2021/084244, filed Dec. 3, 2021, which claims priority to German Application 10 2020 215 328.0, filed Dec. 3, 2020. The disclosures of the above applications are incorporated herein by reference.

### TECHNICAL FIELD

The disclosure relates to a method and a device for controlling an electric drive system for an electric vehicle with two electric machines. At least one of the electric machines is designed for providing traction torque to the drive wheels or to a drive axle of the vehicle. The vehicle can be a pure electric vehicle with only electric motors as drive sources or a hybrid electric vehicle with a combustion engine as an additional drive source.

### BACKGROUND

Electric vehicles with two electric machines are well known, either as pure electric vehicle or as hybrid electric vehicle. Depending on their primary purpose, electric machines differ in technical design, performance specification, voltage level, size and in the way they are integrated into the drive train. In a hybrid electric vehicle with two electric machines and one combustion engine for example, one electric machine usually serves as a traction machine while the other electric machine serves as a starter generator. Whereas the traction machine is connected to one of the drive axles of the vehicle, e.g., via a transmission gearing, the starter generator is connected to the crankshaft of the engine, e.g., via a belt. As a real driving source of the vehicle, the traction machine shows much higher performance characteristics than the starter generator, the main purposes of which are the starting of the combustion engine and the recuperation of kinetic energy.

What all these various types of electric vehicles have in common is an electric energy storage device, e.g., a lithium-ion battery and or a fuel cell, which serves as electric power source and as electric power sink for both electric machines.

### SUMMARY

The disclosure provides a method for controlling an electric system for a vehicle with two electric machines, which allows for an improved power supply of the electric machines and an improved feed-in of recuperation power while protecting the electric system of overuse and damage. The disclosure also provides a control device which is designed and configured to perform the control method.

One aspect of the disclosure provides a control method for controlling an electric system for a vehicle having a machine sub system and a remaining system. The machine sub system includes a first electric machine and a second electric machine. The remaining system includes at least an electric storage device. The method includes the following steps: determining an allowable remaining system power range for the remaining system which is delimited by an upper remaining system power threshold value and a lower remaining system power threshold value; determining an allowable first machine power range for the first electric machine which is delimited by an upper first machine power threshold value and a lower first machine power threshold value; and determining an allowable second machine power range for the second electric machine which is delimited by an upper second machine power threshold value and a lower second machine power threshold value, such that the sum of upper first machine power threshold value and upper second machine power threshold value does not exceed the upper remaining system power threshold value, and that the sum of the lower first machine power threshold value and the lower second machine power threshold value does not exceed the lower remaining system power threshold value. The method also includes determining an allowable first machine torque range based on the allowable first machine power range and a current speed of the first electric machine; determining an allowable second machine torque range based on the allowable second machine power range and a current speed of the second electric machine; and determining a first machine torque setpoint for the first electric machine lying within the allowable first machine torque range and determining a second machine torque setpoint for the second electric machine lying within the allowable second machine torque range based on at least one torque request for operation of the vehicle. The method also includes operating first electric machine to realize first machine torque setpoint and operating second electric machine to realize second machine torque setpoint.

Implementations of the disclosure may include one or more of the following optional features. In some implementations, the first electric machine and the second electric machine are types of electric machines that contribute to the propulsion of the vehicle, either by providing a drive torque to drive axles or to drive wheels of the vehicle, or by providing electric energy used for producing drive torque or by starting a combustion engine. Examples of the first and second electric machines include, but are not limited to, tractions motors like wheel hub motors or motors driving the drive axle of the vehicle, gear box mounted motors, motors mounted between combustion engine and gear box, starter generators (belt-driven starter generator or crankshaft starter generator), pure generator (merely for producing electric energy to be stored in the electric energy device or to be consumed by a traction motor). The first electric motor and the second electric motor do not include motors that are merely used for driving auxiliary devices, e.g., fan motors or fuel pump motors or wind screen wiper motor.

By determining the remaining system power range first, the overall power range available for the machine sub system is set at the beginning of the controlling method. The determination of the remaining system power range considers technical power limits (input power limit and output power limit) of the remaining system, the exceeding of which may harm electric components of the remaining system, e.g., the energy storage device. For this purpose, the upper remaining system power threshold value may be set to a maximum allowable input power value that can be tolerated by the remaining system without damage of certain electric components thereof. Likewise, the lower remaining system power threshold value may be set to a maximum allowable output power value that can be tolerated by the remaining system without damage of certain electric components thereof.

By controlling the sum of the upper first machine power threshold value and the upper second machine power threshold value not to exceed the upper remaining system power threshold value and by controlling the sum of the lower first machine power threshold value and the lower second machine power threshold value not to exceed the lower remaining system power threshold value, the disclosure allows for a save operation of the electric drive system within its technical boundaries and tolerances while safely preventing it from technical damages by overuse.

As it is the sum of upper first machine power threshold value and upper second machine power threshold value that is limited by the upper remaining system power threshold value, it is possible that the upper first machine power threshold value itself may exceed the upper remaining system power threshold value. In this case, the upper second machine power threshold value is set to an appropriate value low enough to compensate for that excess power and to allow for the sum of both values to meet the previously mentioned requirement. Likewise, it is possible that the upper second machine power threshold value itself may exceed the upper remaining system power threshold value. In this case, the upper first machine power threshold value is set to an appropriate value to compensate for that excess power and to allow for the sum of both values to meet the previously mentioned requirement.

This principle equally applies to the lower first machine power threshold value and the lower second machine power threshold value, the sum of which is limited by the lower remaining system power threshold value. This allows for a more flexible adaptation of the individual allowable power ranges of both electric machines in order to adequately respond to specific operating conditions of the electric drive system and to certain power requests which are necessary for operation of the vehicle.

In some examples, as power is the most suitable parameter to define stress limits in an electric drive system, allowable power ranges are determined first while individual allowable torque ranges for the electric machines are determined only afterwards depending on their current speeds. This allows for a very safe and sustainable operation of the electric drive system.

In some implementations, the remaining system further includes at least one electric consumer besides the electric storage device. The allowable remaining system power range is determined based on a currently allowable energy storage output power value and a currently allowable energy storage input power value of the energy storage device and based on a current or a predicted electric consumer input power value of the at least one electric consumer.

In this example, a current or predicted electric power consumption of an electric consumer other than the electric storage device is taken into account for the determination of the allowable remaining system power range. More specifically, the upper remaining system power threshold value is determined by the sum of an input power threshold of the energy storage device (defined as positive or zero) and the current or estimated power consumption value of the electric consumer (defined as positive or zero). This means that the sum of electric power generated by both electrical machines is allowed be higher if such electric consumer is active (consuming electric power). The lower remaining system power threshold value is determined as the sum of an output power threshold of the energy storage device (defined as negative or zero) and the current of estimated power consumption value of the electric consumer (defined as positive or zero). This means that the sum of electric power consumed by both electrical machines is only allowed to be less if such electric consumer is active.

In some implementations, the remaining system includes at least one sensor which captures an operating value of the energy storage device, wherein the allowable remaining system power range is determined such that the operating value does not exceed a given operating threshold value.

By taking into account critical operating values, e.g., temperature, currents, total device voltage or minima or maxima of cell voltages of the energy storage device for determination of the allowable remaining system power range, damage of the energy storage device can be reliably prevented. For instance, if the actual current of a battery exceeds the allowable maximum charge current, a closed loop controller (e.g., PI-controller) can reduce the allowable charge power of the battery used for computation of the upper remaining system power threshold value, thus leading to a reduction of the total electric power that can be generated by the electric machines in combination. The electric machine torque setpoints will then be determined in a way that less electric power is produced in total, and that the current going into the battery is reduced, until the current going into the battery is no longer exceeding the battery discharge power limit. This allows to ensure respecting the battery limits e.g., in case of inaccuracies of values determined by sensors or in case of inaccuracies in the determination of the machine torque setpoints from the allowable electric power. In this way the electric drive system can e.g., always fully use the potential of the system for recuperation, reducing fuel consumption in case of a hybrid vehicle.

In some examples, the energy storage device includes at least one fuel cell. The fuel cell is able to generate electric power output by conversion of stored fuel (e.g., hydrogen). It may be used in combination with another kind of energy storage device, from which it may be physically separated.

In some examples, multiple different torque requests for operation of the vehicle are defined. In this case, the method includes: classifying each of the multiple torque requests in one of multiple torque request categories according to their duration; and determining the upper remaining system power threshold value and the lower remaining system power threshold value depending on a category of a currently active torques request or dependent on the categories of multiple currently active torque requests.

In this example, the usual duration of different torque requests is taken into account for determining the allowable remaining system power range. Torque requests which occur during operation of the vehicle, e.g., ESP torque request, gearshift support torque request, engine starter motor torque request, driver's torque request, usually last for different periods of time. Depending on their average time duration it is possible to widen or to narrow the allowable remaining system power range. For a rather short-lasting torque request, e.g., engine start torque request or a boost torque request (timely limited power enhancement), short-term expansion of the allowable remaining system power range boundaries is acceptable without causing damage to the remaining system. This is because the remaining system can cope with a higher electric power flow for a short period of time. Short-lasting torque requests can thus fully utilize the short-term power capabilities of the remaining system. On the other hand, the remaining system cannot cope with the same electric power flow for a longer period of time. For the purpose of component protection, torque requests which usually last longer, e.g., driver's full load torque request on a highway or a recuperation torque request to one of the electric machines while driving down a mountain pass, require a narrowing of the allowable remaining system power range. Otherwise it would be required to reduce the allowable remaining system power range at some point in time when the remaining system is overloaded (e.g., for thermal reasons), while the respective torque request is still active, thus leading negative effects on drivability and comfort. This is why different torque requests are categorized according to their individual average time durations while the boundaries of the allowable remaining system power range are determined in dependence of the category of a currently effective torque request.

In some implementations, the step of determining the allowable first machine power range and the allowable second machine power range includes steps of: dividing the upper remaining system power threshold value between the upper first machine power threshold value and the upper second machine power threshold value according to a given first rate, such that the sum of the upper first machine power threshold value and the upper second machine power threshold value does not exceed the upper remaining system power threshold value; and/or dividing the lower remaining system power threshold value between the lower first machine power threshold value and the lower second machine power threshold value according to a given second rate, such that the sum of the lower first machine power threshold value and the lower second machine power threshold value does not exceed the lower remaining system power threshold value.

In this example, the allowable remaining system power range, which defines the maximum overall power range available for the machine subsystem, is distributed to (i.e. shared between) the first electric machine and the second electric machine according to predetermined rates. First rate and second rate may be fix values or may be values that vary over time. For example, in an electric vehicle with the first electric machine driving the front axle and the second electric machine driving the rear axle, 50% of the available remaining system output power could be allocated to the first electric machine, and 50% of the available remaining system output power could be allocated to the second electric machine. This generally leads to the best overall efficiency in case of identical electric machines at the front axle and at the rear axle. Different power allocations may be chosen at vehicle acceleration (e.g., higher remaining system output power allocation to the electric machine at the rear axle) or at vehicle deceleration (e.g., higher remaining system input power allocation to the machine at the front axle) to optimize vehicle traction. This procedure of fixing the allocated power per machine a priori has generally the advantage of avoiding that a torque request modifying the power output or power consumption of one of the electric machines (e.g., torque increasing or decreasing stability control intervention at one axle) can lead to a modification of the allowable power output or power consumption of the other electric machine, with disturbing secondary effects on the torque setpoint of that other electric machine.

In some implementations, the step of determining the allowable first machine power range and the allowable first machine power range includes steps of: assigning at least one of the torque requests for operation of the vehicle (200) to only one of the first electric machine and second electric machine; determining the upper power threshold value and/or the lower power threshold value of the respective electric machine such that the respective electric machine can realize the at least one assigned torque request; and determining the upper power threshold value of the other electric machine such that the sum of upper power threshold value of the respective electric machine and upper power threshold value of the other electric machine does not exceed the upper remaining system power threshold value, and determining the lower power threshold value of the other electric machine such that the sum of lower power threshold value of the respective electric machine and lower power threshold value of the other electric machine does not exceed the lower remaining system power threshold value.

In this example, at least one torque request for operation of the vehicle is assigned to only one of the electric machines. This torque request might be a high priority torque request. For example, a sudden driver's full load torque request which is usually considered as an indicator for a critical traffic situation is assigned to the more powerful of both machines. For enabling the respective machine to accomplish that torque request, its allowable power range is suitably dimensioned with priority over the other electric machine. Another example is a driving situation where the vehicle runs down a steep mountain pass road. This driving situation may trigger a recuperation torque request for charging the energy storage device and for relieving the brakes. In order to gain as much recuperation electric power as possible, such torque request may preferably be assigned to the more powerful electric machine. Another example concerns hybrid electric cars including a combustion engine and two electric machines, one of which functions as a starter generator. In a typical situation the engine needs to be started by the starter generator. Such engine start torque request is then assigned to the starter generator which serves as starter for the engine. Since a successful engine start can only be ensured if a certain electric power is available for the starter generator, torque request for engine start may be processed with highest priority. In this case the electric power consumption of the other electric machine will be reduced as much as necessary to ensure a successful engine start.

Another aspect of the disclosure provides a control device adapted to carry out the control method discussed above. The control device includes all hardware components and interfaces which are necessary for that purpose. The method itself is implemented as software code in a memory of the control device and carried out by a processor of the control device.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 depicts schematically a structure of an exemplary electric drive system of a hybrid electric vehicle.

FIG. 2 depicts schematically an exemplary structure of an electric drive system of a pure electric vehicle.

FIG. 3 is a flow chart of an exemplary control method.

FIG. 4 depicts power ranges for a first operating scenario of the electric drive system.

FIG. 5 depicts power ranges for a second operating scenario of the electric drive system.

FIG. 6 depicts power ranges for a third operating scenario of the electric drive system.

Like reference symbols in the various drawings indicate like elements.

### DETAILED DESCRIPTION

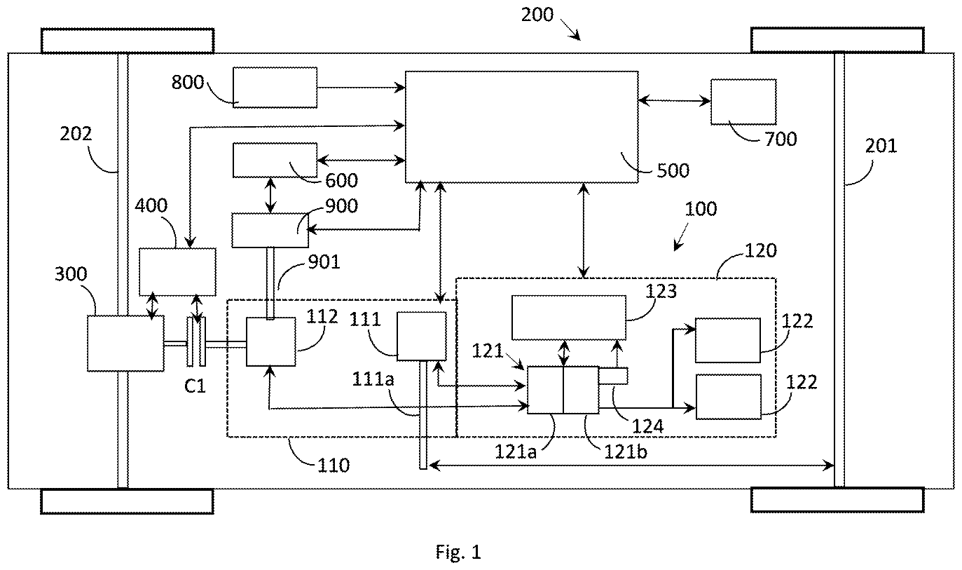

FIG. 1 shows schematically a structure of a first example of an electric drive system 100 for a hybrid electric vehicle 200. The electric drive system 100 includes an electric machine subsystem 110 and a remaining subsystem 120.

The electric machine subsystem 110 includes a first electric machine 111 and a second electric machine 112.

In this first example, the first electric machine 111 is a traction machine and is designed as a drive source for the vehicle 200. The first electric machine 111 may also serve as a generator for recuperating kinetic energy of the vehicle 200. For both purposes, the first electric machine 111 is drivingly connected (double arrow in FIG. 1) to one drive axle 201 of the vehicle 200. More precisely, an output shaft 111a of the first electric machine 111 is connected to drive axle 201, e.g., via a gearing (not shown in FIG. 1).

The second electric machine 112 is designed to serve as a starter generator machine, e.g., a crankshaft starter generator, which is drivingly connected to a crankshaft 901 of a combustion engine 900 and further connectable to a controllable gear box 300 via a controllable clutch C1. Controllable gear box 300 is drivingly connected to the other drive axle 202 of the vehicle 200. Actuation of controllable clutch C1 and controllable gear box 300 is performed by Transmission Control Unit 400. In this example, the second electric machine 112 has different functions. With clutch C1 being disengaged, the second electric machine 112 serves as a starter motor for starting the combustion engine 900 or as a generator for producing electric energy driven by the combustion engine 900. With clutch C1 being engaged, combustion engine 900 is drivingly connected to drive axle 202 via gear box 300.

Due to their different purposes, the first electric machine 111 has significantly higher performance capabilities than the second electric machine 112.

The remaining system 120 at least includes an energy storage device 121. The energy storage device 121 may include e.g., a Li-ion battery 121a and/or a fuel cell 121b. In the first example of FIG. 1 the remaining system further includes several electric consumers 122, e.g., an electric fan for cooling the combustion engine 900 and a compressor for an air conditioning system (not shown in FIG. 1). Another example of an electric consumer 122 could be a DC/DC converter that transfers electric energy e.g., to an electric network with lower voltage level (e.g., 12V power net, not shown in FIG. 1). The remaining system 120 further includes a Battery Management Controller 123 for controlling and monitoring operation of the energy storage device 121. For monitoring purposes, the energy storage device 121 is provided with at least one sensor device 124 for capturing critical operating values of the energy storage device 121, e.g., temperature, overall voltage, cell voltage, input/output current, state of charge. The battery management controller 123 controls operation of the energy storage device 121 depending on critical operating values detected by sensors 124. As an example, if temperature exceeds a critical threshold value, power input and power output of the energy storage device 121 are reduced. Moreover, the Battery Management Controller 123 takes care that electric power flow (input and output power flow) and voltage of the energy storage device 121 stay within certain allowable ranges to avoid damage and overuse.

The electric energy storage device 121 has double functionality. First, the electric energy storage device 121 serves as an electric power source for all electric components of the vehicle 200. For that purpose, the energy storage device 121 is connected to all electric components via electric wires. Second, the electric energy storage device 121 serves as an electric energy accumulator for receiving and storing electric energy. That electric energy may be produced and fed to the energy storage device 121 either by an external electric power source (e.g., external power charger, not depicted) or by the first and second electric machines 111, 112 while being operated as generators (e.g., by recuperating kinetic energy of the vehicle).

The vehicle 200 further includes an Engine Control Unit 600 for controlling the combustion engine 900, an optional Stability Control Unit 700 which processes control functions for vehicle driving stability (e.g., anti-spinning function), and a Powertrain Domain Control Unit 500.

The Powertrain Domain Control Unit 500 serves as a master control unit for managing at least all processes, torque or power requests involved in driving the vehicle. Powertrain Domain Control Unit 500 is at least provided with a processor, a memory and several interfaces. For sending and/or receiving data signals and control signals, the Powertrain Domain Control Unit 500 is linked to all electric components involved in operating the vehicle 200 via signal transmitting wires or via wireless signal transmitting connections (e.g., Bluetooth, etc). Signal transmission might be one way or two way. Among others, the Powertrain Domain Control Unit 500 is linked to the electric machine subsystem 110, the remaining subsystem 120, the Engine Control Unit 600, the Vehicle Stability Control Unit 700, a driving pedal 800 by which a vehicle driver (not depicted) can adjust acceleration, deceleration and travel speed of the vehicle 200. At any time, the Powertrain Domain Control Unit 500 is in knowledge of all information necessary to evaluate the driving condition of the vehicle and of all information necessary to coordinate multiple request necessary for operation of the vehicle 200. For example, Powertrain Domain Control Unit 500 coordinates all torque requests occurring during operation of the vehicle. For example, in response to a driver's torque request (driver actuates the driving pedal 800) Powertrain Domain Control Unit 500 orders the first electric machine 111 and/or combustion engine 900 to produce and transmit an adequate driving torque to the drive axles 201, 202. In case that the Stability Control Unit 700 detects any unwanted vehicle instability, the Powertrain Domain Control Unit 500 reduces or increases the torque request by an adequate amount to restore vehicle stability.

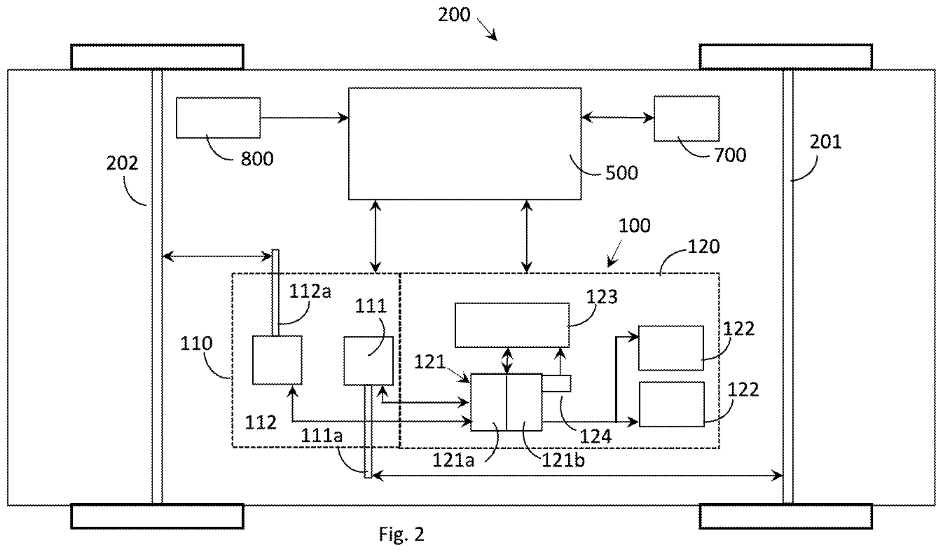

FIG. 2 shows schematically a structure of a second example of an electric drive system 100 for a pure electric vehicle 200. In this second example, the vehicle 200 does not have a combustion engine as a drive source. Instead, the second electric machine 112 is adapted to serve as a traction motor for driving the vehicle 200. The second electric machine 112 may also serve as a generator for recuperating kinetic energy of the vehicle 200. For both purposes, the second electric machine 112 is drivingly connected (double arrow in FIG. 2) to drive axle 202. More precisely, an output shaft 112a of the second electric machine 112 may be connected to drive axle 202 via a gearing (not shown in FIG. 2). The second electric machine 112 shows significantly enhanced performance values compared to the first example. Consequently, the second example lacks an Engine Control Unit, a controllable gear box, clutch C1, and a Transmission Control Unit.

Apart from the differences described above, the remaining structure and components of the second example are identical to that of the first example. Respective parts of the description of the first example equally apply to the second example.

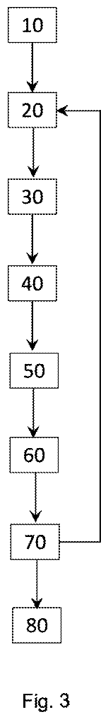

In the following, a method for controlling the electric drive system 100 is described with reference to FIGS. 3 to 6. The method is implemented as software in the Powertrain Domain Control Unit 500.

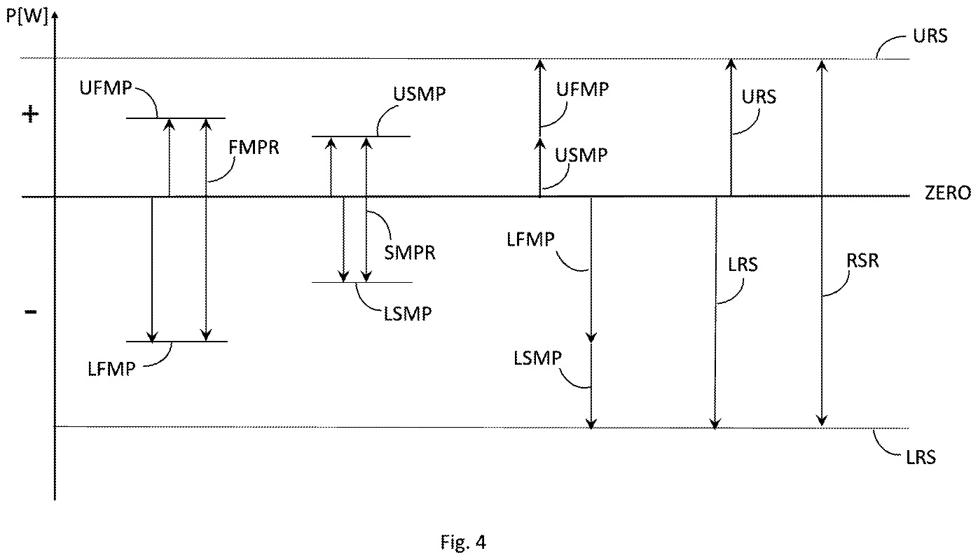

For a better understanding of the individual method steps, reference is made to diagrams of FIGS. 4 to 6, where electric power is plotted on the vertical axis P, while the zero-power line is represented by horizontal zero-power line ZERO. The area beneath the zero-power line ZERO is the negative electric power area, while the positive electric power area extends above the zero-power line ZERO.

From the perspective of the first and second electric machines 111, 112, positive electric power (positive sign “+”) means power generation, i.e., the respective electric machine 111, 112 is operated in a generator operating mode with electric power being produced and supplied to the remaining system 120. From the perspective of the first and second electric machine 111, 112, negative electric power (negative sign “−”) means power consumption, i.e., the respective electric machine 111, 112 is operated in a motor operating mode with torque being produced and electric power being consumed.

In the diagrams of FIGS. 4 to 6 upper remaining system power threshold value URS and lower remaining system power threshold value LRS are upper and lower boundaries of allowable remaining system power range RSR. Allowable remaining system power range RSR represents the maximum allowable power range that can be handled by the remaining system 120 without causing technical problems or damage within the remaining system 120.

Therefore, the upper remaining system power threshold value URS represents a maximum amount of electric power that is allowed to be fed into the remaining system 120. Generally, electric power generated by the energy machine subsystem 110 is fed into the remaining system 120 so as to be stored as electric energy in the electric storage device 121 and/or to be consumed by electric consumers 122. However, electric power load on the energy storage device 121 is limited. Therefore, upper remaining system power threshold value URS depends on a currently allowable energy storage input power value EIP (not depicted) and on one or more current electric consumer input power values CIP. The latter represents the power consumption amount by one or more active consumers 122. Currently allowable energy storage input power value EIP represents the current electric power that can be fed into the electric energy storage device without causing harm to it.

Thus, in a first situation where electric power fed into the remaining system 120 is shared between one or more active consumers 122 and the energy storage device 121, the overall amount of electric power that is allowed to be fed into the remaining system 120 is higher than in a second situation where no consumer 122 is active and where the energy storage device 121 has to take all the electric power fed into the remaining system 120. In other words, in the first situation the upper remaining system power threshold value URS can assume a higher positive value than in the second situation.

Likewise, the lower remaining system power threshold value LRS represents a maximum amount of electric power that is allowed to be output by the remaining system 120 and fed into the electric machine subsystem 110. Usually, electric power furnished to the electric machine subsystem is provided by the energy storage device 121, at least in part. However, the amount of power the energy storage device 121 can provide is limited. Therefore, lower remaining system power threshold value LRS depends on currently allowable energy storage output power value EOP and on the one or more current electric consumer input power values CIP. Currently allowable energy storage output power value EOP represents the current electric power that can be output by the electric energy storage device without causing harm to it. Thus, in a third situation where one or more active consumers 122 are consuming a portion of the electric power furnished by the energy storage device 121, the remaining amount of electric power that can be supplied to the electric machine subsystem 110 is lower than in a fourth situation where no consumer 122 is active and where all electric energy supplied by energy storage device 121 is available to the electric machine subsystem 110. In other words, in the fourth situation the lower remaining system power threshold value LRS can assume a more negative value than in the third situation.

The extent of the remaining system power range RSR is not a fix. Its boundaries, the upper remaining system power threshold value URS and the lower remaining system power threshold value LRS, may vary over time dependent on several factors. As explained above, one factor is the operating state (active or inactive) of consumers 122. Another major factor is the current condition of the electric energy storage device 121 which significantly impacts the currently allowable energy storage output power value EOP and the currently allowable energy storage input power value EIP.

Condition of the electric energy storage device 121 depends on multiple technical parameters or operating values, i.e., temperature, overall voltage, cell voltage, state of charge, age, etc. Most of these parameters or values are measurable or calculatable. At least some of the measurable parameters are captured by sensor devices 124 (see FIGS. 1 and 2) and respective values are transferred to the Battery Management Controller 123. Other parameters may be calculated by the Battery Management Controller 123. The upper remaining system power threshold value URS and the lower remaining system power threshold value LRS are determined in dependence of at least one of these operating values or technical parameters. For instance, with rising temperature of electric energy storage device 121, currently allowable energy storage output power value EOP and currently allowable energy storage input power value EIP are diminished. Thus, with rising temperature of energy storage device 121 the remaining system power range RSR is shrinking, and with declining temperature of energy storage device 121 the remaining system power range RSR is widening (unless extremely low temperature values are reached that lead again to a reduced remaining system power range RSR).

In method step 10 of FIG. 3, processing of the method is started by the Powertrain Domain Control Unit 500.

In step 20, the allowable remaining system power range RSR for the remaining system 120 is defined by determining the upper remaining system power threshold value URS and the lower remaining system power threshold value LRS. As described above, the allowable remaining system power range RSR is determined based on the currently allowable energy storage input power value EIP and the currently allowable energy storage output power value EOP of the energy storage device 121, and based on the current electric consumer input power value CIP of the at least one electric consumer 122. Alternatively, the electric consumer input power value CIP may also be derived from a predicted power value of a consumer which is expected to be activated in the near future. By considering estimated future power consumption of the electric consumer 122 for the determination of the electric consumer input power value CIP prior to the activation of the respective consumer, the electric drive system 100 is well prepared for sudden activation of the respective consumer 122. Currently allowable energy storage output power value EOP and currently allowable energy storage input power value EIP are provided by the battery management controller 123.

The following equations may be applied:

URS=|EIP|+|CIP|

LRS=−|EOP|+|CIP|

The upper remaining system power threshold value URS and the lower remaining system power threshold value LRS are further determined in dependence of at least one operating value of the electric energy storage device 121 captured by a sensor 124, such that the operating value does not exceed a predetermined operating threshold value. E.g., upper remaining system power threshold value URS and the lower remaining system power threshold value LRS are determined such that temperature of electric energy storage device, which is captured by a temperature sensor, does not exceed a certain temperature threshold value given by the battery management controller 123.

Usually, during operation of the vehicle multiple torque requests need to be fulfilled by the electric drive system 100. For instance, the vehicle driver has a certain torque request which is expressed by the degree of actuation of the driving pedal 800. Other torque requests come from the Transmission Control Unit 400, e.g., a torque requests to support gear shifting, or are generated within the Powertrain Domain Control Unit 500 for maintaining the charge balance of the energy storage device, e.g., request for charging the energy storage device by operating one of the electric machines 111, 112 as generator in case of low state of charge determined by the Battery Management Controller 123. In some situations, there is a need to start the combustion engine, resulting in a torque request for the second electric machine 112. These multiple torque request usually differ from each other by their duration. For instance, the driver's torque request usually is a long-term torque request. A torque request addressed to the second electric machine 112 for starting the combustion engine 900 or for supporting gear shifting is a short-term torque request. Torque requests addressed to one of the electric machines 111, 112 for charging the energy storage device 121 usually are long-term torque requests. The energy storage device 121 can typically cope with high power input and output for a short period of time but not for a longer period of time. This is due to e.g., heating up of components within the energy storage device 121. Therefore, upper remaining system power threshold value URS and lower remaining system power threshold value LRS may be altered in dependence of the duration of respective torque requests which are about to be fulfilled. Therefore, according to the method, each of the multiple torque requests are being classified in torque request categories according to their duration. The upper remaining system power threshold value URS and the lower remaining system power threshold value LRS are then determined depending on the category of a current torque request or dependent on the categories of multiple current torque requests.

For instance, category 1 includes short-term torque requests, e.g., engine start torque request (negative electric power sign) and engine stop support torque request (positive electric power sign). Engine start is performed by the second electric machine 112 by rotating the crankshaft of the engine while consuming electric power provided by the remaining system 120 (energy storage device 121). Engine stop support is performed by the second electric machine 112 while being operated as generator, thus generating electric power which is supplied to the remaining system 120.

Category 2 includes long-term torque requests, e.g., driver's torque request for acceleration (negative electric power sign) and energy storage charging torque request (positive electric power sign). Driver's torque request is fulfilled by the first electric machine 111 by providing drive axle 201 with torque while consuming electric power provided by the remaining system 120 (energy storage device 121). Charging torque request may be realized by first or second electric machines 111, 112 while being operated as generators, thus generating electric power which is supplied to the remaining system 120.

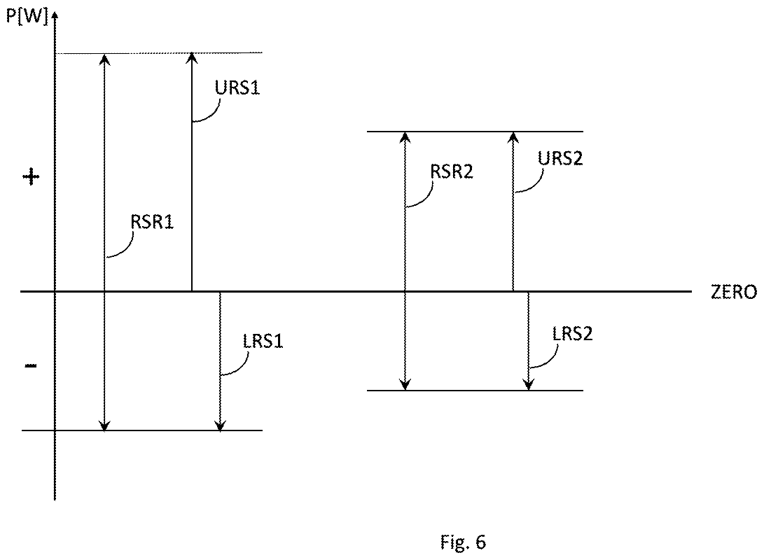

With reference to FIG. 6, for short lasting torque requests of category 1, the allowable remaining power range RSR1 is determined to be wider, thus allowing the electric machine subsystem to consume or produce high electric power for a short period of time. All short lasting torque requests can benefit from this widened allowable remaining power range RSR1, which can improve the performance of the respective functions. For long lasting torque requests of category 2, the allowable remaining power range RSR2 is determined to be narrower, thus allowing the electric machine subsystem to consume or produce lower electric power but for a longer period of time.

In method step 30 (see FIG. 3) an allowable first machine power range FMPR is determined for the first electric machine 111 which is delimited by a upper first machine power threshold value UFMP and a lower first machine power threshold value LFMP, and an allowable second machine power range SMPR is determined for the second electric machine 112 which is delimited by a upper second machine power threshold value USMP and a lower second machine power threshold value LSMP, such that the sum of the upper first machine power threshold value UFMP and the upper second machine power threshold value USMP does not exceed the upper remaining system power threshold value URS and the sum of the lower first machine power threshold value LFMP and the lower second machine power threshold value LSMP does not exceed the lower remaining system power threshold value LRS. The following conditions apply:

UFMP+USMP≤URS (Condition 1)

and

LFMP+LSMP≥LRS (Condition 2)

These rules for determining the upper and lower first machine power threshold value UFMP, LFMP and for upper and lower second machine power threshold value USMP, LSMP are better explained with reference to diagram of FIG. 4 which applies to both vehicle configurations as shown in FIGS. 1 and 2.

In FIG. 4 the lower remaining system power threshold value LRS and upper remaining system power threshold value URS delimit the remaining system power range RSR. The lower remaining system power threshold value LRS is in the negative power area (negative sign “−”) as it represents the maximum allowable power amount to be consumed by the electric motor subsystem 110 and provided by the remaining system 120. The upper remaining system power threshold value URS is in the positive power area (positive sign “+”) as it represents the maximum allowable power amount to be generated by the electric motor subsystem 110 and fed into the remaining system 120.

Both lower remaining system power threshold value LRS and upper remaining system power threshold value URS are determined by the Battery Management Controller 123 and provided to the Powertrain Domain Control Unit 500. In knowledge of the values LRS and URS, the Powertrain Domain Control Unit 500 will determine first machine power range FMPR and second machine power range SMPR by allocating power values to upper and lower first machine power threshold values UFMP, LFMP and to upper and lower second machine power threshold values USMP, LSMP. As a first alternative of determination, allocation is done by sharing the upper remaining system power threshold value URS between the upper first machine power threshold value UFMP and the upper second machine power threshold value USMP according to first rate, e.g., 3/2. For instance, 60% of the upper remaining system power threshold value URS are allocated to the upper first machine power threshold value UFMP and 40% thereof are allocated upper second machine power threshold value USMP. Likewise, lower remaining system power threshold value LRS is shared between the lower first machine power threshold value LFMP and the lower second machine power threshold value LSMP according to a given second rate, e.g., 3/2. For instance, 60% of the lower remaining system power threshold value LRS are allocated to the lower first machine power threshold value LFMP and 40% thereof are allocated to lower second machine power threshold value LSMP. This simple way of allocation ensures that both Condition 1 and Condition 2 are met.

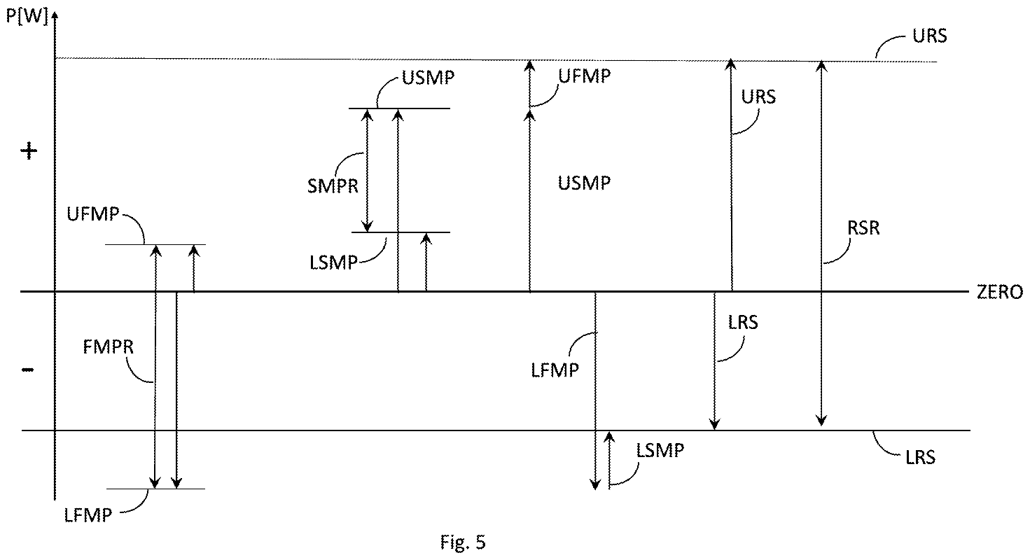

FIG. 5 shows an alternative method for determining allowable first machine power range FMPR and allowable second machine power range SMPR from the remaining system power range RSR. This alternative is applicable to a hybrid electric vehicle as shown in FIG. 1. For instance, in a driving situation where the vehicle driver requests full torque (drive pedal 800 fully pressed), e.g., for overtaking a lorry on a highway, while the lower remaining system power threshold value LRS is insufficient for realizing the driver's torque request by the first electric machine 111 even if the lower first machine power threshold value LFMP is set to LRS. For solving that problem, the driver's torque request is assigned to the first electric machine 111. In knowledge of the current speed of first electric machine, lower first machine power threshold value is calculated such that the first electric machine 111 can realize the driver's torque request. As can be seen in FIG. 5, in this situation, lower first machine power threshold value will exceed lower remaining system power threshold value LRS on the negative power side. As condition 2 still needs to be met, lower second machine power threshold value needs to be set to a positive value. This means that the second electric machine needs to generate electric power to compensate for the lack of electric power the remaining system 120 is not allowed or able to provide. For this purpose, while the first electric machine 111 drives the vehicle, clutch C1 is disengaged and combustion engine 900 is started for driving the second electric machine 112 for generating electric power.

In method step 40 (see FIG. 3) an allowable first machine torque range is determined based on the allowable first machine power range FMPR and a current speed of the first electric machine 111, and an allowable second machine torque range is determined based on the allowable second machine power range SMPR and a current speed of the second electric machine. Conversion of power into torque depending on speed is well known in the art.

In method step 50 (see FIG. 3), based on at least one torque request for operation of the vehicle, a first machine torque setpoint for the first electric machine 111 is determined within the allowable first machine torque range, and/or a second machine torque setpoint for the second electric machine 112 is determined within the allowable second machine torque range. For instance, if the driver's torque request lies within the first machine torque range, the driver's torque request is set as first machine torque setpoint.

In method step 60 (see FIG. 3), the first electric machine 111 is operated to realize the first machine torque setpoint and/or the second electric machine 112 is operated to realize the second machine torque setpoint.

In method step 70 (see FIG. 3) the method either returns to step 20 (during operation of the vehicle) or proceeds to step 80 where the method is terminated (e.g., with driver disabling the electric drive system at the end of driving)

A number of implementations have been described. Nevertheless, it will be understood that various modifications may be made without departing from the spirit and scope of the disclosure. Accordingly, other implementations are within the scope of the following claims.

What is claimed is:

1. A method for controlling an electric drive system for an electric vehicle, the electric drive system being subdivided in an electric machine subsystem comprising a first electric machine and a second electric machine and in a remaining subsystem comprising at least an energy storage device, the method comprising:
determining an allowable remaining system power range for the remaining subsystem which is delimited by an upper remaining system power threshold value and a lower remaining system power threshold value;
determining an allowable first machine power range for the first electric machine which is delimited by an upper first machine power threshold value and a lower first machine power threshold value;
determining an allowable second machine power range for the second electric machine which is delimited by an upper second machine power threshold value and a lower second machine power threshold value, a sum of the upper first machine power threshold value and the upper second machine power threshold value does not exceed the upper remaining system power threshold value and a sum of the lower first machine power threshold value and the lower second machine power threshold value does not exceed the lower remaining system power threshold value;
determining an allowable first machine torque range based on the allowable first machine power range and a current speed of the first electric machine;
determining an allowable second machine torque range based on the allowable second machine power range and a current speed of the second electric machine;
determining a first machine torque setpoint for the first electric machine within the allowable first machine torque range and determining a second machine torque setpoint for the second electric machine within the allowable second machine torque range based on at least one torque request for operation of the vehicle;
operating the first electric machine to realize the first machine torque setpoint; and
operating the second electric machine to realize the second machine torque setpoint.

2. The method of claim 1, wherein the remaining subsystem further comprises at least one electric consumer and wherein the allowable remaining system power range (RSR) is determined based on a currently allowable energy storage input power value and a currently allowable energy storage output power value of the energy storage device and based on an electric consumer input power value of the at least one electric consumer.

3. The method of claim 1, wherein:
the remaining subsystem comprises at least one sensor device, the at least one sensor device captures an operating value of the energy storage device, and
the allowable remaining system power range (RSR) is determined such that the operating value does not exceed a predetermined operating threshold value.

4. The method of claim 3, wherein the energy storage device comprises at least one fuel cell.

5. The method of claim 1, wherein multiple torque requests for operating the vehicle exist, and the determination of the allowable remaining system power range includes:
classifying each of the multiple torque requests in one of multiple torque request categories according to their duration; and
determining the upper remaining system power threshold value and the lower remaining system power threshold value depending on a category of a current torque request or dependent on categories of multiple current torque requests.

6. The method of claim 1, wherein determining the allowable first machine power range and the allowable second machine power range includes:
dividing the upper remaining system power threshold value between the upper first machine power threshold value and the upper second machine power threshold value according to a given first rate, such that the sum of the upper first machine power threshold value and the upper second machine power threshold value does not exceed the upper remaining system power threshold value; and/or
dividing the lower remaining system power threshold value between the lower first machine power threshold value and the lower second machine power threshold value according to a given second rate, such that the sum of the lower first machine power threshold value and the lower second machine power threshold value does not exceed the lower remaining system power threshold value.

7. The method of claim 1, wherein determining the allowable first machine power range and the allowable first machine power range includes:
assigning at least one of the torque requests for operation of the vehicle to only one of the first electric machine and second electric machine;
determining the upper power threshold value and/or the lower power threshold value of the respective electric machine such that the respective electric machine can realize the at least one assigned torque request;
determining the upper power threshold value of the other electric machine such that the sum of upper power threshold value of the respective electric machine and upper power threshold value of the other electric machine does not exceed the upper remaining system power threshold value; and
determining the lower power threshold value of the other electric machine such that the sum of lower power threshold value of the respective electric machine and lower power threshold value of the other electric machine does not exceed the lower remaining system power threshold value.

8. A device for controlling an electric system for an electric vehicle, the electric system comprising:
a machine sub-system including:
a first electric machine, and
a second electric machine; and
a remaining system including at least an electric storage device, wherein the device is configured to execute a control method according to claim 1.
